(19) United States
(12) Patent Application Publication
(10) Pub. No.: US 2015/0102645 A1
(43) Pub. Date: Apr. 16, 2015

(54) UNIVERSAL COVER FOR SEAT AND BACK SUPPORT

(71) Applicant: JOHN H. ROGAN, Calabash, NC (US)

(72) Inventor: JOHN H. ROGAN, Calabash, NC (US)

(21) Appl. No.: 14/514,355

(22) Filed: Oct. 14, 2014

Related U.S. Application Data
(60) Provisional application No. 61/890,430, filed on Oct. 14, 2013.

(51) Int. Cl. A47C 31/11; B60N 2/60

(52) U.S. Cl. CPC A47C 31/11; B60N 2/6063; B60N 2/6018; B60N 2/60
USPC 297/228.11; 297/229; 297/228.13

(57) ABSTRACT

A universal seat cover including an expanse of fabric with a top end and a bottom end, and an inverted pocket with a contractible opening containing an elastic braid such that the inverted pocket hugs the seat over which it is fitted or placed. The universal seat cover also has an aperture through which a head rest can be fitted. The aperture can be made to be resealable by the inclusion of one or more zipper assemblies. One or more pockets can be attached to the face of the expanse of fabric.

### CROSS-REFERENCE TO RELATED APPLICATIONS

This application further claims the benefit of U.S. Provisional Application Ser. No. 61/890,430 filed Oct. 14, 2013, which is also hereby incorporated by reference in its entirety.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field of the Invention

The present invention is in the technical field of protective covers for seats, chairs, and the like. More particularly, the present invention is in the technical field of fabric covers designed for universal application to a variety of seat, chair, and back support designs.

2. Background Art

Seat covers are frequently used to protect the surface of a seat or chair from the wear and tear of everyday use, including but not limited to soiling of the seat or chair surface via repeated and frequent contact with unclean or wet persons or clothing. Though use of seat covers and variety in the design of seat covers are both well-known in the art, there is a continuing and apparent need for a seat cover that is universal in its ability to fit onto a variety of seat or chair back support designs, including without limitation back support designs involving a rounded or uneven border at their top.

At present, automobile seat covers do not readily adapt and fit to a beach chair, a beach chair seat cover does not readily adapt and fit to a dining room chair, and a dining room chair does not readily adapt and fit to a recliner, and so on and so on. This lack of universality in design of the current seat covers known in the art requires a user of seat covers to purchase and install a differing specific seat cover design for each differing specific seat, chair or back support design for which use is desired. This lack of universality makes for both the cumbersome and unduly expensive protection of multiple seats, chairs or back supports.

One attempt in the art to address the problems herein cited is a prior art embodiment employing the use of a pocket at the top of the seat cover that is designed to envelop the top of a variety of back support designs. Despite being a step in the right direction to remedy the cited problems, this embodiment still has the problem that the enveloping pocket, though being large enough to be used with a variety of sizes and shapes of back supports, does not snugly fit any one or more variations in the back support design. In this sense, this attempt in the art to address the problems cited comprises a universal solution that surrenders effectiveness in fit to achieve the universality sought. Accordingly, despite this advance, there remains a need for an embodiment of the seat cover that achieves universality of design without compromising the effectiveness of the seat cover to snugly fit each of the various designs of back supports to which the seat cover is intended to be applied.

Another attempt in the art to address the problems herein cited is a prior art embodiment employing the use of an aperture in the seat cover that allows the cover to fit a standard automobile bucket seat and have the headrest protrude through the cover—the specific design allows this seat cover to fit a variety of automobile seats but does not allow for the cover to fit any other type of seat, chair, or back support design. Accordingly, this particular prior art embodiment has nearly universal application for automobile seats, but is useless with regard to nearly any other type of chair, seat or back supports, including without limitation beach chairs, recliners, and dining room chairs.

### BRIEF SUMMARY OF THE INVENTION

The present invention is a universal cover for fit and use on a variety of back support designs, the cover comprising an expanse of fabric sufficient to completely cover the front surface of a back support, a pocket on the backside of the expanse positioned at the top of the expanse and of sufficient width to envelop the top of the back support and an elastic hem defining the mouth of the pocket. The description of the preceding sentence (the “broadest contemplated embodiment”) is what is considered to be the broadest embodiment of the now disclosed invention. That said, embodiments of increasing specificity are disclosed below, including without limitation the preferred embodiment that is discussed in detail beneath the heading “Detailed Description of the Invention”.

An alternative and more specific embodiment of the presently disclosed invention entails a universal cover for fit and use on a variety of back support designs, the cover comprising an expanse of fabric of sufficient dimension to completely cover both the front surface of a back support and the top surface of a seating platform, a pocket on the backside of the expanse positioned at the top of the expanse and of sufficient width to envelop the top of the back support and an elastic hem defining the mouth of the pocket. In this sense, this alternative embodiment is intended to have specific utility for use with both a traditional seat or chair in addition to structures consisting of only a back support including without limitation certain gym equipment and exercise machines.

In both the broadest contemplated embodiment and the alternative embodiment identified above, a primary inventive feature of each embodiment is deemed to be the pocket on the backside of the expanse of fabric, positioned at the top of the expanse and of sufficient width to envelop the top of the back support, and an elastic hem defining the mouth of the pocket. In tandem, the pocket and the elastic hem are the operable features of the invention that allow the universal fit and usage of the cover across a variety of seat, chair and back support designs. In short, the operative mechanism yielding the invention's superior effectiveness to the existing prior art is the combination of (i) the size differential between the contracted elastic hem and the actual width of the pocket at the top backside of the expanse of fabric, and (ii) the ability of the elastic hem to stretch to the width of the pocket and collapse upon a back support inserted into the pocket thus providing a snug fit to the back support by way of the tension caused in stretching the elastic hem about the top of the back support. In the inventor's estimation, the vast majority of chair, seat and back support types to which the present invention may be applied are between 15 inches and 27 inches in width and, therefore, the inventor contemplates that the width of the pocket at the top backside of the expanse of fabric is likely to have the most universality of application if the pocket itself is at least 15 inches and at most 27 inches in width. In a preferred embodiment, the pocket at the top backside of the expanse of fabric is 6 inches in depth thus allowing 6 inch overlap of the pocket about the top of a back support—the inventor believes this length is the minimum depth for the pocket that may be utilized without sacrificing stability and snugness of fit about the top of a back support.

In all circumstances of application of the now disclosed invention, the inventor contemplates the elastic hem defining the mouth of the pocket at the top backside of the expanse of fabric to be substantially shorter in width that the pocket itself when contracted, thus causing the operative gripping tension force when the same is extended and placed about the top of a back support. In a preferred embodiment, the elastic hem defining the mouth of the pocket at the top backside of the expanse of fabric is specifically comprised of a ¼ inch elastic braid integrated within the hem, the contracted elastic braid being at least 25% shorter in length than the width of the pocket at the top backside of the expanse of fabric to which it is applied. In a further preferred embodiment, the contracted elastic braid integrated within the hem defining the mouth of the pocket at the top backside of the expanse of fabric is at least 50% shorter in length than the width of the pocket to which it is applied.

In both the broadest contemplated embodiment and alternative embodiment identified above, it is contemplated that either embodiment may further comprise an aperture in the pocket that may be opened or closed via fastening means. The aperture provides means for the protrusion of a headrest through the universal cover and is envisioned to be particularly useful in the context of seats that traditionally feature a headrest separate and distinct from the back support such as automobile seats and barber chairs. Stated with more specificity, the fastening means that facilitate the alternating opening and closure of the aperture is contemplated to be a zipper assembly in what is thought to be the best mode of the present invention. Stated with even more specificity, the contemplated zipper assembly is preferably a double-zipper assembly allowing the aperture to be opened only as far as needed to allow a particular headrest to protrude through the cover by pulling the two zipper sliders in divergent directions from the center of the double-zipper assembly then causing the cover to fit about the base of the headrest snugly by pulling the two zippers in convergent directions about the base of the headrest. In a preferred embodiment, the aperture and thus the double-zipper assembly are each 20 inches in width, thus resulting in an aperture having a 40 inch circumference when the two zipper sliders are pulled in divergent directions from the center of the double-zipper assembly and the aperture is completely opened.

In both the broadest contemplated embodiment and alternative embodiment identified above, it is deemed desirable by the present inventor that the expanse of fabric recited be constituted of a polyester-composite fabric, and specifically a composite of 80% polyester and 20% polyamide composite fabric. A polyester-composite fabric composition of the expanse of fabric yields superior moisture absorption qualities when compared to a standard cotton terry-cloth construction and, specifically, the 80% polyester and 20% polyamide composition is known in the art to allow for moisture absorption at a volume of seven (7) times the weight of the fabric. Accordingly, it is believed that the composition of the cover from this 80% polyester and 20% polyamide composite will result in more effective and efficient absorption of fluid spills upon the cover and, therefore, more effective and efficient protection of the seat, chair, or back support surface beneath the cover.

In both the broadest contemplated embodiment and alternative embodiment identified above, it is contemplated that either embodiment may further comprise at least one additional pocket affixed to the frontside of the expanse of fabric. Unlike the recited pocket located at the top of the backside of the expanse of fabric, the contemplated pocket(s) affixed to the frontside of the expanse of fabric are intended to serve the purpose of convenient storage compartments for a user rather that serve an intrinsic function in the fitting of the cover to a particular seat, chair, or back support. Accordingly, in what is deemed a preferred embodiment of the now disclosed invention, the expanse of fabric would have at least a single pocket affixed to the bottom frontside of the expanse of fabric, thus allowing this front side pocket to dangle vertically from a back support or seat platform to which the cover has been applied. The inventor believes that this configuration would allow for the recited frontside pocket to be utilized for the effective storage of keys, sunglasses, and similar personal effects with minimal intrusion upon the seating or back support surface and minimum compromise of the primary protective utility of the invention.

### BRIEF DESCRIPTION OF THE SEVERAL VIEWS OF THE DRAWINGS

FIG. 1 is a front view of the contemplated best mode of the present invention;

FIG. 2 is a rear view of the contemplated best mode of the present invention while in use on an upright folding lawn chair;

FIG. 3 is a rear perspective view of featuring the backside pocket in the contemplated best mode of the present invention; and

FIG. 4 is a perspective view of the contemplated best mode of the present invention while in use on a standard automobile seat.

### DETAILED DESCRIPTION OF THE INVENTION

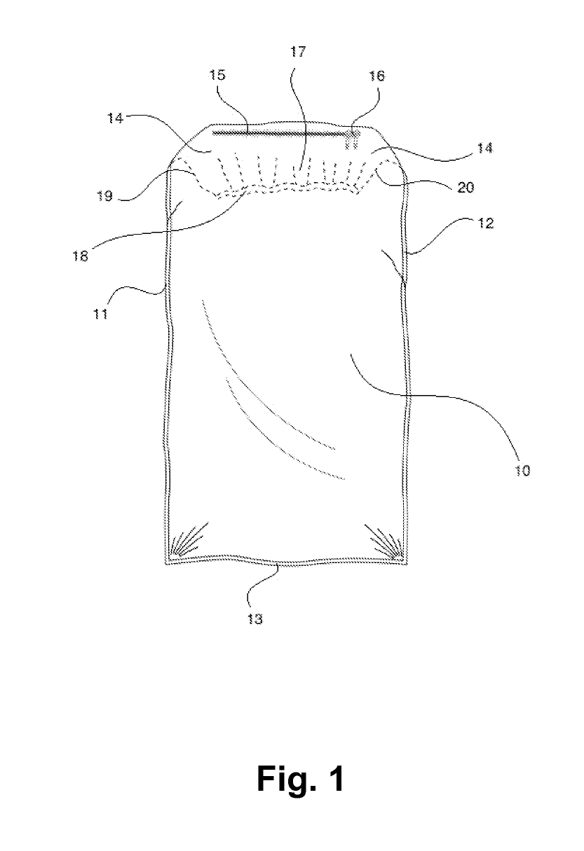

Referring now to the invention in more detail, in FIG. 1 there is shown a front view of the contemplated best mode of the present universal cover invention, the view depicting the present invention and identifying features present in the view numbered 10 through 20. Specifically, there is shown a fabric expanse 10 defined by a left edge 11, right edge 12, bottom edge 13, and top portion 14 that is folded back upon itself and sewn along the left edge 11 forming a right seam 20 defining the right extent of the pocket, and likewise sewn along the right edge 12 forming a left seam 19 defining the left extent of the pocket. The folding of the top portion 14 back upon itself and the sewn left seam 19 and right seam 20 collectively serve to form a backside pocket 17, the backside pocket 17 having an opening defined by an elastic hem 18. The sides of the backside pocket 17 are defined by a left seam 19 and a right seam 20, the left seam 19 and the right seam 20 being at the intersection of the backside pocket 17 side edges with the backside of the fabric expanse 10 wherein each backside pocket edge 17 is permanently affixed to the backside of the fabric expanse 10 by binding tape, sewn seam or such other method of binding two pieces of fabric together as may be readily known to one skilled in the art of sewing. Further depicted in FIG. 1 is a zipper track 15 in the deepest portion of the backside pocket 17 that also happens to be one inch to the rear of the top edge of the fabric expanse 10 when the fabric expanse 10 is viewed from the front. By offsetting the position of the zipper track 15 away from the apex of the top edge of the fabric expanse 10, the inventor seeks to retain the fabric's inherent strength and flexibility at this critical location, while preventing any undue stress on the zipper track 15. As might be expected, the zipper track 15 is coupled with two zipper sliders 16 to complete the full zipper assembly. As depicted, the two zipper sliders 16 are as far right as possible in the zipper track 15 and the zipper track 15 is locked together in a “closed” configuration as opposed to the zipper track 15 being depicted in an “open” configuration thereby illustrating an aperture in the backside pocket 17 contemplated in the now disclosed best mode.

In more detail, still referring to the invention of FIG. 1, the universal cover invention as shown includes the fabric expanse 10 that ultimately rests upon a contemplated back support and seat platform, if any, thus protecting the back support and seat platform from any number of happenings, elements or variables that may damage the same, including without limitation, dirt, grime, food and drink spillage, direct sunlight, wet swimsuits, perspiration and pet stains. The universal cover is installed upon a back support, chair or seat in such way that the left edge 11, right edge 12, and bottom edge 13 of the fabric expanse 10 each overhang the edges of the back support, seat or chair upon which the universal cover has been installed to ensure complete coverage of all surfaces that may be otherwise contacted by happenings, variables, or elements damaging or soiling the back support, seat or chair. The universal cover is held in place by insertion of the top of a back support into the backside pocket 17 defined by the fabric expanse 10 folding upon itself and being affixed in place by the left seam 19 and right seam 20 formed at the intersection of the folded over left edge 11 and right edge 12 of the fabric expanse 10 with the backside of the fabric expanse 10. In this sense, the backside pocket 17 is formed wholly from the folding of the fabric expanse 10 back upon itself and the remaining opening of the pocket is then defined by the elastic hem 18, the elastic within being of substantially shorter left-to-right length than the fabric expanse 10, resulting in the elastic hem 18 constricting around the top of a back support inserted into the backside pocket 17 and holding the fabric expanse 10 tight upon the back support by the tensional force of the elastic hem 18 attempting to contract back to the elastic hem 18 resting shape and size. Further, the zipper track 15 depicted one inch to the rear of the apex of the fabric expanse 10 (or the deepest portion of the backside pocket 17 depending on your frame of reference) is the mechanism whereby the universal cover will fit upon nearly any back support having a separate and distinct headrest. When the zipper slides 16 depicted are moved in divergent directions along the zipper track 15, the zipper track 15 is converted to an “open” configuration through which a headrest may protrude as the backside pocket 17 envelops the top of a back support as held in place by the constrictive force of the elastic hem 18 defining the opening of the backside pocket 17. Once the headrest is protruding through the aperture in the backside pocket 17 left by the “open” configuration zipper track 15, the zipper slides 16 may then be moved along the zipper track 15 in convergent directions to the extent that a user is able to do so, thus causing the zipper track 15 to close tightly about the base of the protruding headrest.

In further detail, still referring to the invention of FIG. 1, the fabric expanse 10 is contemplated to be of a length sufficient to allow the bottom edge 13 of the fabric expanse 10 to overhang the bottom edge of a back support or the front edge of a seat platform over which the fabric expanse 10 is placed. Due to the universal nature of the contemplated cover invention, the length of the fabric expanse 10 should be such that the bottom edge of the fabric expanse 10 would readily overhang the vast majority of back support, chair and seat designs on the market. Likewise, the inventor has determined that the vast majority of back supports on the market are between fifteen inches and twenty-seven inches in width and, for this reason, the fabric expanse 10 is anticipated to be between fifteen inches and twenty-seven inches in width to allow the backside pocket 17, formed from the fabric expanse 10, to be of sufficient width to aptly receive and fit upon the majority of chair, seat, and back support designs on the market. As described above, the operative force that maintains the backside pocket 17 upon the top of a back support is the tensional force generated by the constriction of the backside pocket 17 elastic hem 18 about the top of the back support. In order to generate the necessary constriction and tension, it is contemplated that the elastic hem 18 is preferably at least twenty-five percent shorter in left-to-right width than the backside pocket 17 and the fabric expanse 10. In fact, in the contemplated best mode, the elastic hem 18 is at least fifty percent shorter in left-to-right width than the backside pocket 17 and the fabric expanse 10, thus increasing the distance that the elastic hem 18 must be stretched to envelop the top of a back support thereby significantly increasing the constrictive and tensional forces exerted by the elastic hem 18 upon the top of the back support. In terms of construction and composition, there is nothing particularly notable about the zipper track 15 and zipper slides 16 combined assembly—these may be of any standard form commonly known in the garment industry. In terms of length and as considered in the best mode, the zipper track 15 is contemplated to be twenty inches in length, thus resulting in an aperture having a forty inch circumference when the zipper track 15 is opened by pulling the zipper slides 16 in divergent directions.

The construction details of the invention as shown in FIG. 1 are that the fabric expanse 10 is preferably constituted from an eighty percent polyester/twenty percent polyamide composite fabric. The inventor cites this particular composition due to its known capacity to absorb seven times its weight in moisture, a trait that the inventor believes particularly desirable in a seat cover protecting a seat, chair or back support from dirt, grime, spillage, perspiration, and/or pet stains among other events that may be detrimental to the preservation of the seat, chair or back support beneath. As before mentioned, in terms of construction and composition, there is nothing particularly notable about the zipper track 15 and zipper slides 16 combined assembly—these may be of any standard form commonly known in the garment industry. As for the backside pocket 17, again it is contemplated that the pocket itself is constituted from the fabric expanse 10 folding back upon itself and, therefore, the backside pocket 17 would likewise be constituted from the same eighty percent polyester/twenty percent polyamide composite fabric constituting the fabric expanse 10.

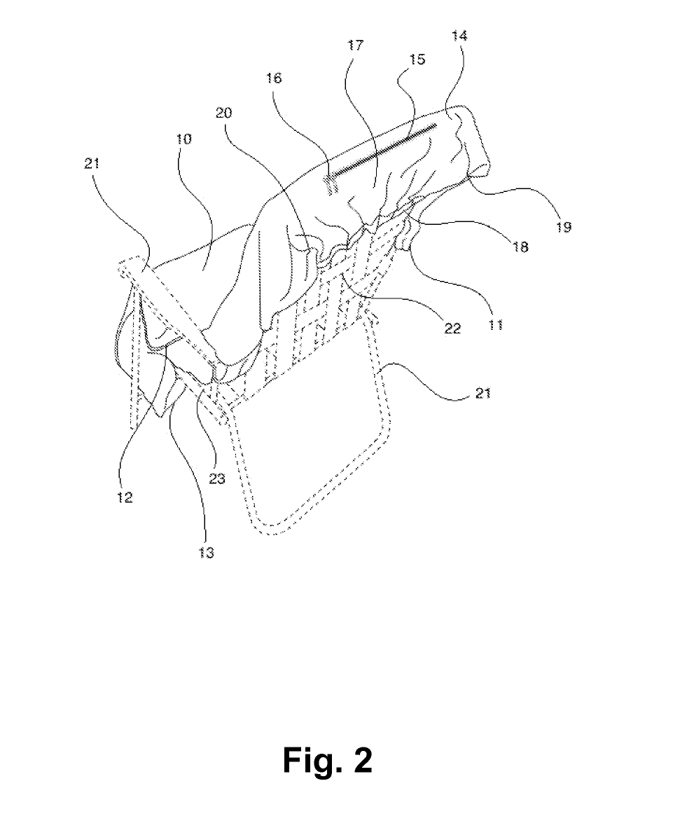

Referring now to the invention in more detail, in FIG. 2 there is shown the best mode of the now contemplated invention as the same might look when in use upon a common lawn chair 21. Again, there is shown a fabric expanse 10 defined by a left edge 11, right edge 12, bottom edge 13, and top portion 14 that is folded back upon itself to form a backside pocket 17, the backside pocket 17 having an opening defined by an elastic hem 18. The sides of the backside pocket 17 are defined by a left seam 19 and a right seam 20, the left seam 19 and the right seam 20 being at the intersection of the backside pocket 17 side edges with the backside of the fabric expanse 10 wherein each backside pocket edge 17 is permanently affixed to the backside of the fabric expanse 10 by binding tape, sewn seam or such other method of binding two pieces of fabric together as may be readily known to one skilled in the art of sewing. Further depicted in FIG. 2 is a zipper track 15 in the deepest portion of the backside pocket 17 that also happens to be one inch to the rear of the apparent top edge of the fabric expanse 10 when the fabric expanse 10 is viewed from the front. As might be expected, the zipper track 15 is coupled with two zipper sliders 16 to complete the full zipper assembly. As depicted, the two zipper sliders 16 are as far right as possible in the zipper track 15 and the zipper track 15 is locked together in a “closed” configuration as opposed to the zipper track 15 being depicted in an “open” configuration thereby illustrating an aperture in the backside pocket 17 contemplated in the now disclosed best mode. As depicted, the backside pocket envelops the back support 22 of the lawn chair 21 and the fabric expanse 10 completely covers the front side of the back support 22 and the seat platform 23 of the lawn chair 21.

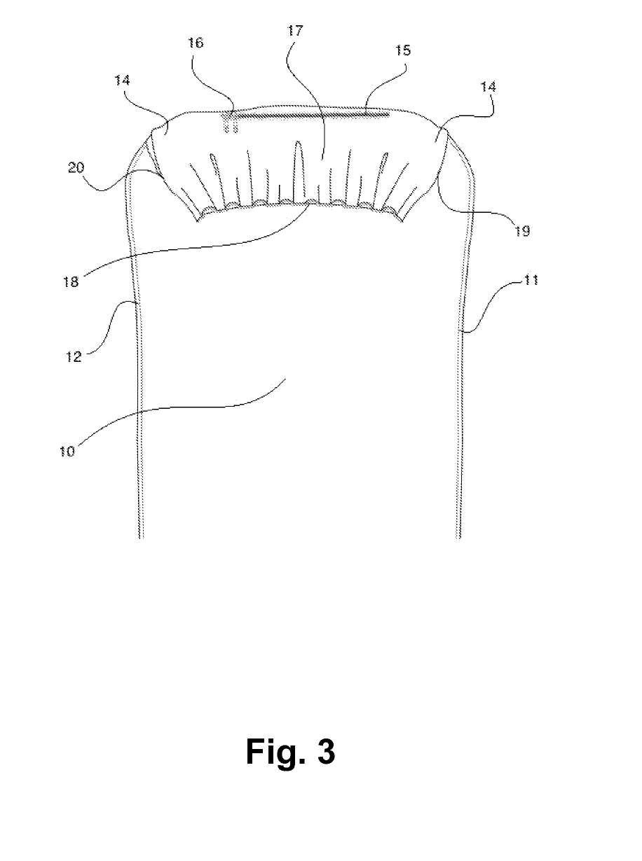

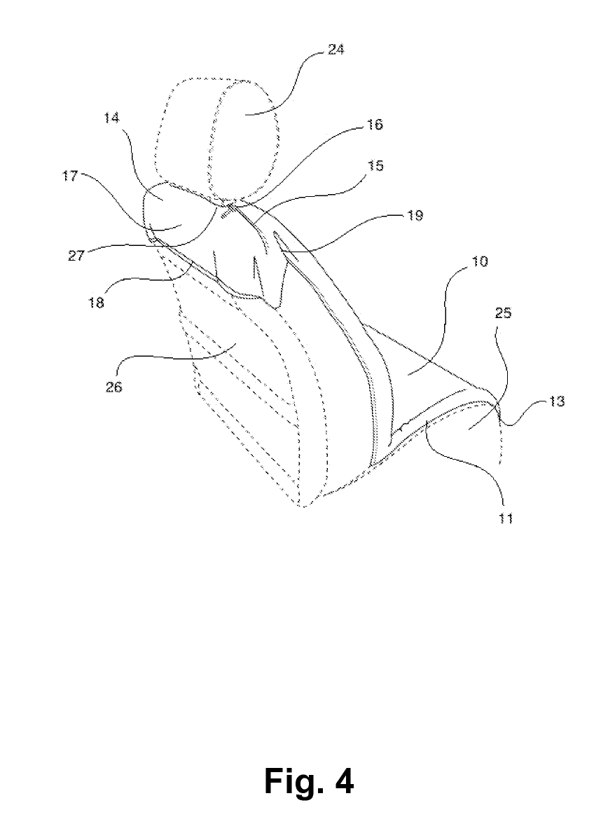

Referring now to the invention in more detail, in FIG. 3 there is shown the now contemplated best mode having the backside pocket 17 featured in the perspective view show. Whereas FIG. 1 depicted the best mode of the now disclosed inventive apparatus from the front with the backside pocket 17 essentially hidden from view, this FIG. 3 exists for the sole purpose of highlighting the backside pocket 17, thus allowing a better understanding of its composition and functionality. In this view, there is again depicted the fabric expanse 10, though this time from the back view, said fabric expanse defined by a left edge 12, a right edge 11, and a top portion 14, as shown, and a bottom edge which is not shown. FIG. 3 clearly demonstrates the top portion 14 of the fabric expanse 10 folding back upon itself to form the backside pocket 17, again defined by an elastic hem 18 at the mouth, a left seam 20, and a right seam 19, the left seam 20 and right seam 19 being affixed to the back of the fabric expanse 10, thus forming the backside pocket 17. Further appreciated from this view is the placement of the double-zipper assembly comprising the zipper track 15 and a pair of zipper slides 16 at the deepest point of the back side pocket 17—the double zipper assembly is explored more in depth in FIG. 4 to follow.

Referring now to the invention in more detail, in FIG. 4 there is shown the best mode of the now contemplated invention as the same might look when in use upon a common automobile seat comprising a back support 26, seat platform 25, and headrest 24. As in all the other views shown and described, there is shown a fabric expanse 10 defined by a left edge 11, bottom edge 13, and top portion 14, as shown, and a right edge that is not shown in this view. The fabric expanse 10 is folded back upon itself and sewn along left edge 11 and right edge 12 to form a backside pocket 17, the backside pocket 17 having an opening defined by an elastic hem 18. The sides of the backside pocket 17 are defined by a left seam 19 and a right seam that cannot be seen in the present view. As depicted, the left seam 19 is at the intersection of the backside pocket 17 side edges with the backside of the fabric expanse 10 wherein each edge of the backside pocket is permanently affixed to the backside of the fabric expanse 10 by binding tape, sewn seam or such other method of binding two pieces of fabric together as may be readily known to one skilled in the art of sewing. Further depicted in FIG. 4 is a zipper track 15 in the deepest portion of the backside pocket 17 that also happens to be the apparent top edge of the fabric expanse 10 when the fabric expanse 10 is viewed from the front. As might be expected, the zipper track 15 is coupled with two zipper sliders, one shown 16 in this view and the other obscured by the headrest 24. The zipper track 15 coupled with the two zipper sliders 16 complete the full zipper assembly. As depicted, the two zipper sliders 16 have been pulled in divergent directions thus opening the zipper track 15 to reveal an aperture 27 through which the automobile headrest 24 protrudes. As depicted, the backside pocket envelops the back support 26 of the automobile seat and the fabric expanse 10 completely covers the front side of the back support 26 and the seat platform 25, while the headrest 24 remains uncovered, protruding through the aperture 27 in the deepest point of the backside pocket 17.

Reference throughout the specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout the specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

It is understood that the above described embodiments are only illustrative of the application of the principles of the present invention. The present invention may be embodied in other specific forms without departing from its spirit or essential characteristics. The described embodiment, including the best mode, is to be considered in all respects only as illustrative and not restrictive. The scope of the invention is, therefore, indicated by the appended claims, if any, in conjunction with the foregoing description.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A universal seat cover comprising—
an expanse of material with a top end and a bottom end; and
said top end having an inverted pocket with a contractible opening.

2. The universal seat cover of claim 1 wherein the contractible opening of the inverted pocket is an elastic hem.

3. The universal seat cover of claim 2 wherein the elastic hem comprises a ¼″ elastic braid integrated within a hem.

4. The universal seat cover of claim 2 wherein the inverted pocket further comprises an aperture that may be opened or closed via fastening means.

5. The universal seat cover of claim 2 further comprising at least one additional pocket affixed to the frontside of the expanse of material.

6. The universal seat cover of claim 4 wherein the fastening means is a zipper assembly.

7. The universal seat cover of claim 6 wherein the zipper assembly is a double-zipper assembly.

8. The universal seat cover of claim 7 wherein the elastic hem comprises a ¼″ elastic braid integrated within a hem.

9. The universal seat cover of claim 8 further comprising at least one additional pocket affixed to the frontside of the expanse of material.

10. The universal seat cover of claim 9 wherein the expanse of material is constituted of a polyester-composite fabric.

11. The universal seat cover of claim 10 wherein the contractible opening of the inverted pocket is between 15″ and 27″ in width.

12. The universal seat cover of claim 1 further comprising at least one additional pocket affixed to the frontside of the expanse of material.

13. The universal seat cover of claim 1 wherein the expanse of material is constituted of a polyester-composite fabric.

14. The universal seat cover of claim 1 wherein the contractible opening of the inverted pocket is between 15″ and 27″ in width.

15. The universal seat cover of claim 1 wherein the inverted pocket further comprises an aperture that may be opened or closed via fastening means.

16. The universal seat cover of claim 15 wherein the fastening means is a zipper assembly.

17. The universal seat cover of claim 16 wherein the zipper assembly is a double-zipper assembly.

18. The universal seat cover of claim 15 further comprising at least one additional pocket affixed to the frontside of the expanse of material.

19. The universal seat cover of claim 15 wherein the contractible opening comprises a ¼″ elastic braid integrated within a hem.

20. A universal seat cover comprising—
an expanse of polyester-composite fabric with a top end and a bottom end;
an inverted pocket with a contractible opening 15″ to 27″ in width comprising an elastic braid integrated within a hem positioned at the top end of the expanse of polyester-composite fabric;
an aperture in the inverted pocket;
means whereby the aperture in the inverted pocket may be interchangeably opened or closed, said means comprising a single-zipper or double-zipper assembly; and
at least one pocket affixed to the face of the expanse of polyester-composite fabric opposite the inverted pocket.
